(19) United States
(12) Patent Application Publication
(10) Pub. No.: US 2014/0315059 A1
(43) Pub. Date: Oct. 23, 2014

(54) CONTROLLED EROSION SYSTEMS PRODUCING ELECTRIC ENERGY

(71) Applicant: Georgios VILANAKIS, Iraklio Crete (GR)

(72) Inventor: Georgios VILANAKIS, Iraklio Crete (GR)

(21) Appl. No.: 14/277,814

(22) Filed: May 15, 2014

Related U.S. Application Data
(63) Continuation-in-part of application No. PCT/GR2011/000051, filed on Nov. 17, 2011.
(60) Provisional application No. 61/824,302, filed on May 16, 2013.

(51) Int. Cl. H01M 10/38

(52) U.S. Cl. CPC H01M 10/38
USPC 429/82; 429/119; 429/72

(57) ABSTRACT

The disclosed embodiments relate to systems that produce electric energy.

### CROSS-REFERENCE TO RELATED APPLICATION

This Application claims the benefit of U.S. Provisional Patent Application 61/824,302 filed May 16, 2013 of George VILANAKIS, the contents of which are herein incorporated by reference.

This Application in a continuation-in-part of International Patent Application PCT/GR2011/000051 of George VILANAKIS filed Nov. 17, 2011, the contents of which are herein incorporated by reference.

### BACKGROUND

The present embodiments relate to systems that produce electric energy.

1. Description of the Related Art

Alternative sources of energy such as wind and solar energy are considered “clean” energy sources in that they do not emit, or cause pollutants to be introduced into the environment. Such energy sources are an attractive solution to the worldwide electric power generation problem and are increasingly utilized to provide clean energy. The production and efficiency of these systems, however, (such as wind generators and photovoltaic systems) depend on such variables as prevailing weather conditions, and the climate of the location in which they are installed.

Batteries of a closed type have been attempted which are capable of being activated by immersion in either salt water, fresh water or in some other electrolytic medium. These batteries are of a closed type and experience continuous erosion. Therefore, such batteries have a short lifetime. As such, clean energy batteries with longer lifetimes would be useful in addressing the worldwide electric power generation problem.

### SUMMARY

Some embodiments relate to electric power production systems including a main inner metal element-rod (1), an outer metal casing-sleeve (3) and liquid absorption and retention materials (2) being interposed between them. In some embodiments, these systems use a liquid, such as water, to initiate and activate the electric power production process, without using additional electrolyte. In some embodiments an open type (controlled erosion) system surrounded from a perforated frame is provided. The main inner metal element-rod (1) can have a rectangular form, for example, and be manufactured at least from magnesium (Mg) or from magnesium (Mg) as basic metal, in combination with at least one or more metals such as aluminum (Al), zinc (Zn), manganese (Mn), silicon (Si), copper (Cu), nickel (Ni) and iron (Fe). The outer metal casing-sleeve (3) can include, for example, pure copper in braided form, and include multi-collector copper conductors. In some embodiments, the liquid absorption and retention material includes a synthetic fabric of high density and absorbency including, for example, cellulose and cotton in combination with a thin layer of sodium polyacrylate.

### BRIEF DESCRIPTION OF THE DRAWINGS

The subject of the embodiments will be better understood by reference to the accompanying drawings, which show an illustrative and not at all restrictive application example, as a whole and in partial details constituting it, wherein:

FIG. 1 shows the main inner metal element-rod according to some embodiments.

FIG. 2 shows the second element, liquid absorption and retention materials according to some embodiments.

FIG. 3 shows the third element, the outer metal casing-sleeve according to some embodiments.

FIG. 4 shows the combination of first and second element according to some embodiments.

FIG. 5 shows the combination of three elements according to some embodiments.

FIG. 6 shows a complete element according to some embodiments.

FIGS. 7A, 7B, and 7C show a complete open-type system including multiple elements according to some embodiments.

FIG. 8 shows the main inner metal element-rod according to other embodiments.

FIG. 9 shows the second element, liquid absorption and retention materials according to other embodiments.

FIG. 10 shows the third element, the outer metal casing-sleeve according to other embodiments.

FIG. 11 shows the combination of first and second element according to other embodiments.

FIG. 12 shows the combination of three elements according to other embodiments.

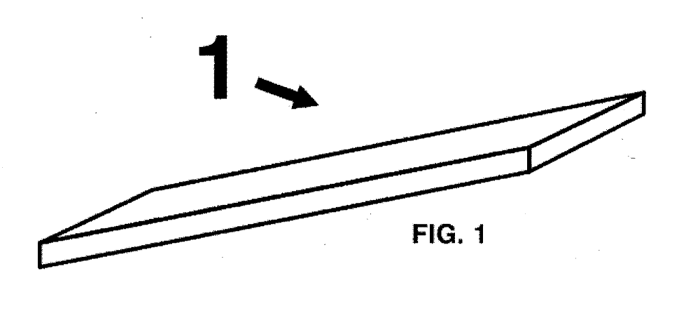

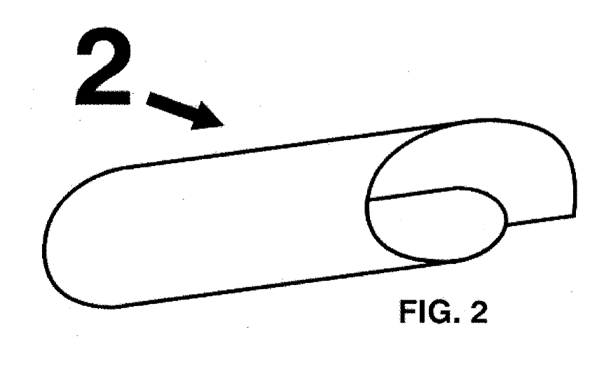

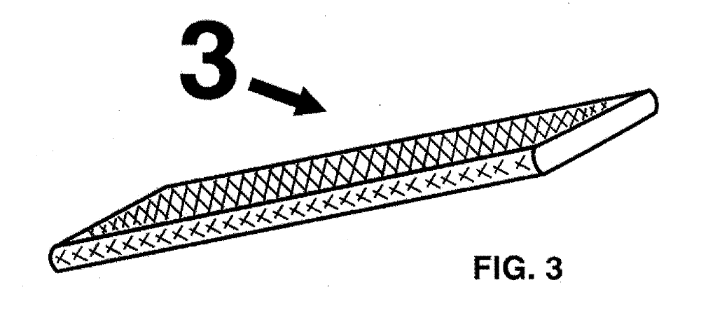

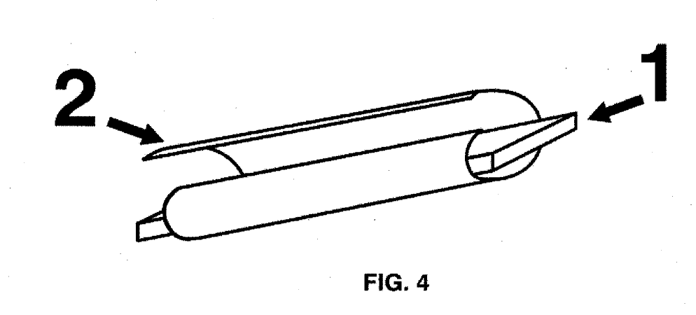

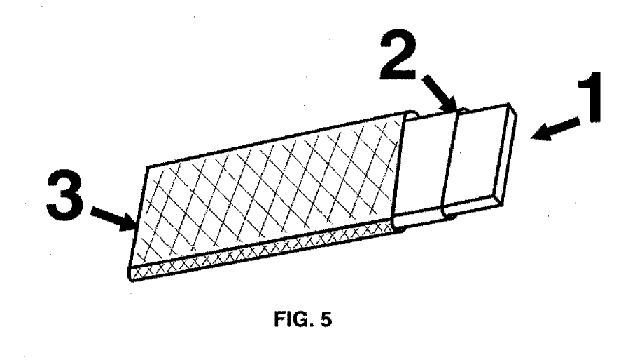

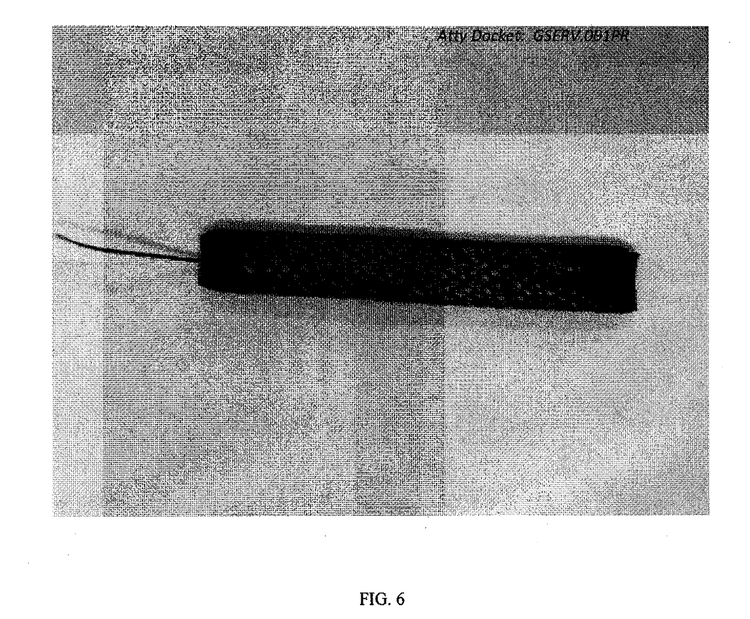

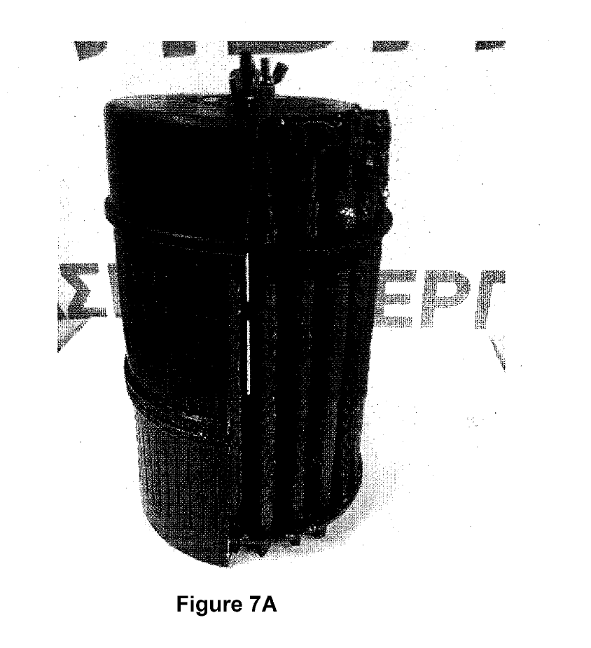

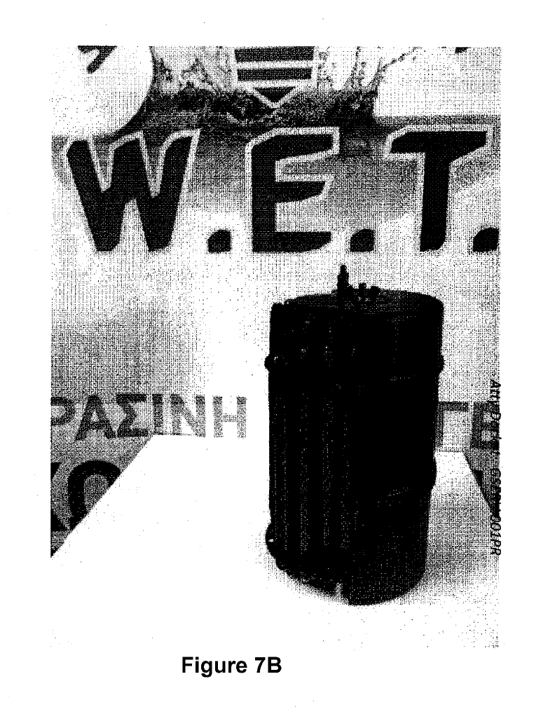

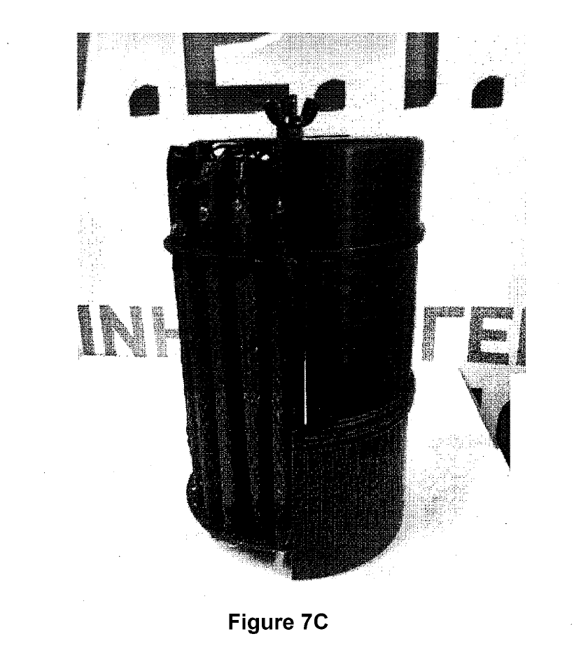

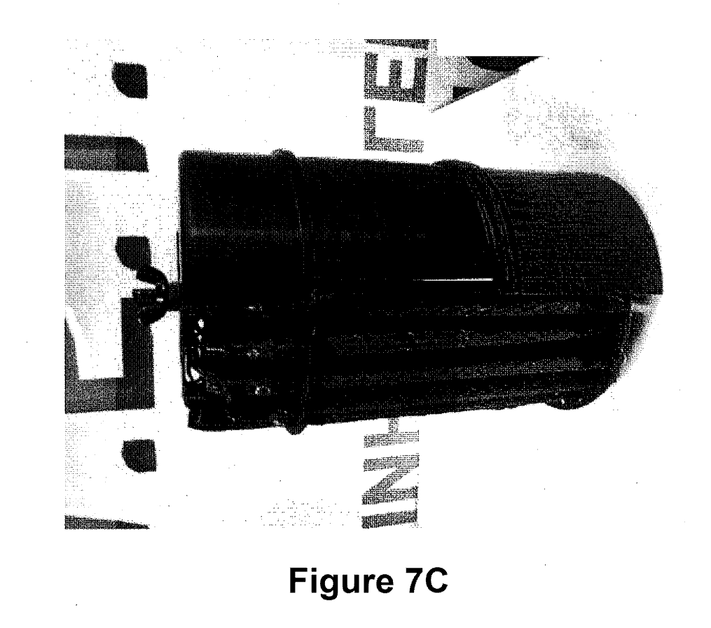

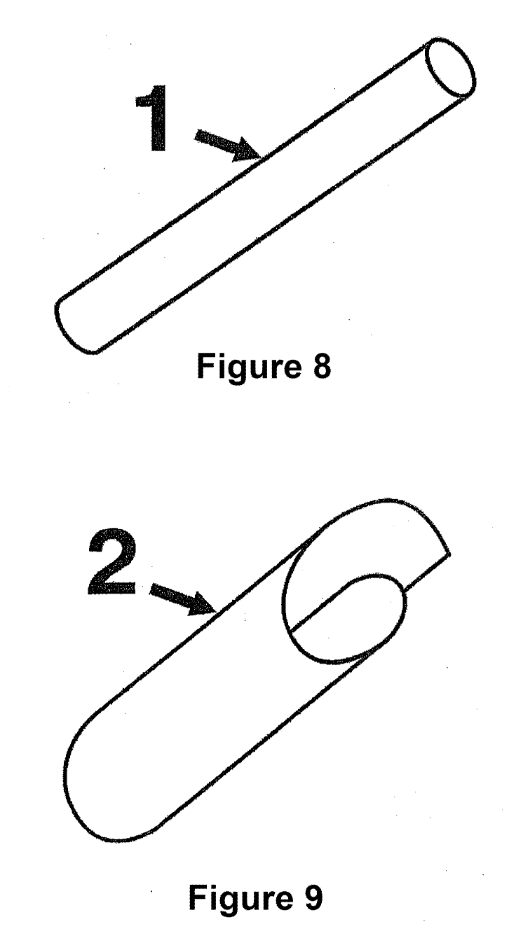

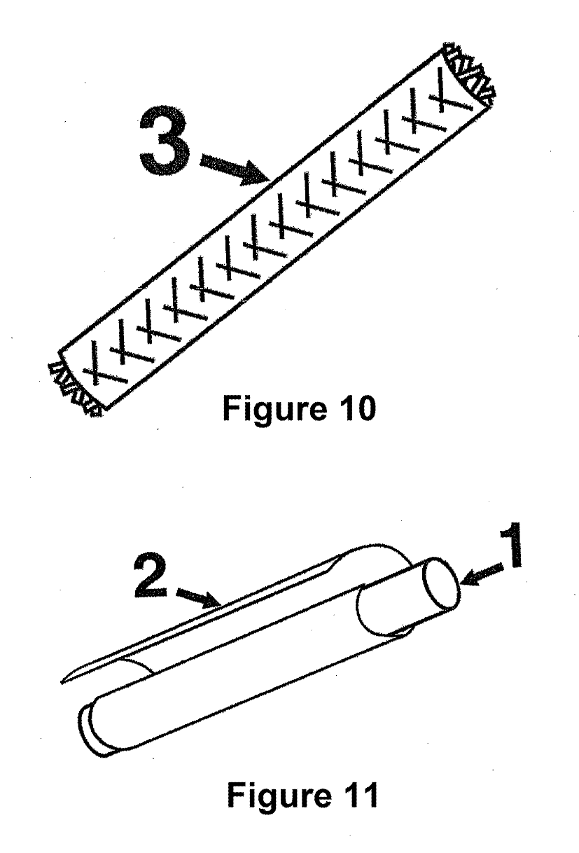

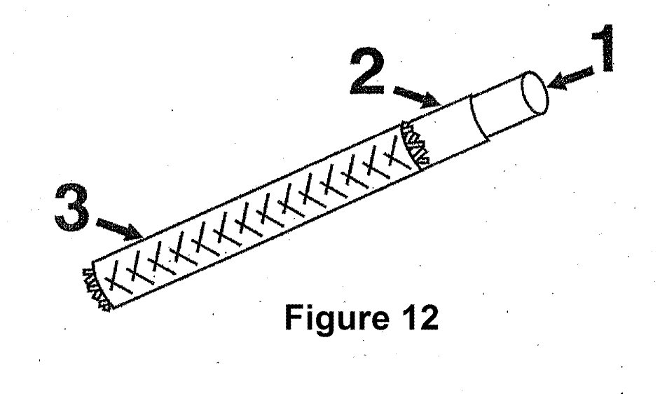

### DETAILED DESCRIPTION OF THE EXEMPLARY EMBODIMENTS

The systems of the present embodiments are characterized as controlled erosion systems, because they need not remain in liquid and are also open type. Instead, the systems can be immersed in a liquid, water for example, for a few seconds and when dry, (a possibility provided by their manufacturing method) the metal erosion procedure is stopped until they are again immersed in or contacted with liquid. As a result, the user of the system can control the erosion of the metals.

The present embodiments provide easy to use, affordable, self-contained electric power production systems of an open type involving controlled erosion. Such systems are superior to closed type and continuous erosion devices that are only capable of storing electric energy. The systems of the present embodiments have the ability to ensure uninterrupted electric power generation up to twenty four hours a day, anywhere and under any weather conditions, requiring no additional installation or the use of a disposable power source. Such disposable power sources may increase costs, lead to destruction of the system if left unused for a long period of time and cause environmental pollution.

The systems of present embodiments are achieved by manufacturing electric power production systems that are of an open type and capable of being activated to generate power within a few seconds of being immersed in or contacted with liquid, water for example, and operating continuously for as long as the anode is kept moist. These systems do not require using additional electrolytes, which would result in the deterioration of the main metal element rod. These systems can undergo many repeated, continuous or occasional uses. They are also useful in emergency situations. The systems can use fresh water or sea water, or any other liquid as an initiation and maintaining generation process medium. They also undergo no deterioration while they remain inactive, or prior to their first activation, during which time they neither create nor emit pollutants.

The electric power production systems of the present embodiments include a main inner element-rod and an outer metal casing-sleeve, in combination with liquid absorption and retention materials, being interposed between them and are characterized in that that they are of an open type and use water, or any other liquid, to initiate and maintain electric power production. The liquid contacted to the systems can be absorbed and held by liquid absorption and retention materials, following the immersion of the system in liquid or contact of the system with liquid. In this way, the moisture required for the activation and operation of the system can be provided. The system will then remain in a continuous operational condition until full evaporation of the liquid element takes place. This is indicated by a drop in system output which signals that re-immersion in liquid or additional contact with liquid should be carried out if the system is required to remain activated. Moreover, no additional electrolyte quantity are required. This prevents deterioration of the main inner element-rod (anode) which extends the lifetime of the system.

The electric power production systems of the present embodiments include a main inner element-rod(!), including, for example, an eight metal polymer alloy, including magnesium (Mg), aluminum (Al), zinc (Zn), manganese (Mn), silicon (Si), copper (Cu), nickel (Ni) and iron (Fe) and have the form of a rectangular rod, an outer metal casing-sleeve (3), including, for example, pure copper in a braided form, which can include multi-collector copper conductors and liquid absorption and retention materials (2) interposed between them. In an example embodiment, the basic metal from which the main inner metal element-rod is constructed (1) is magnesium (Mg) and the rest of the metals have approximately the following proportions: aluminum (Al) from about 5.3% to about 6.7%, zinc (Zn) from about 2.5% to about 3.5%, manganese (Mn) from about 0.15% to about 0.8%, silicon (Si) about 0.15% maximum, copper (Cu) about 0003% maximum, nickel (Ni) about 0.003% maximum and iron (Fe) about 0.003% maximum. In some embodiment the outer metal casing-sleeve (3) is constructed from pure copper about 99%, having a braided form and the specific knitting about 48× about 54× about 0007, and the liquid absorption and retention materials (2). In some embodiments, the liquid absorption and retention materials are a high density and absorbency synthetic fabric including cotton and cellulose in combination with a thin layer of sodium polyacrylate capable of absorbing up to 300 times its own weight or, for example, a fabric, sponge or any other material suitable for this purpose. In some embodiments, the system is being enclosed in an open type perforated frame.

Not wishing to be bound by any particular theory, it is believed that the role of each one of the above mentioned metals used for the construction of the element-rod (1), is as follows: by adding aluminum (Al) the structure and the homogenous molding of the alloy are improved, through zinc (Zn), heat treatment and extrusion are facilitated, through manganese (Mn), the structure and the fluidness of the alloy are improved having as a result a high molding pressure, through silicon (Si) the conductivity is improved and also high fluidness and low shrinkage in the molding as well as conglutination and improvement of the resistance are ensured. Finally through copper (Cu) in combination with nickel (Ni) and iron (Fe) the resistance to erosion is increased.

Lengthy laboratory studies have demonstrated that the outer metal casing-sleeve (3) of pure copper 99%, having a braided form and the specific knitting 48×54×0,07, ensure an efficient breathing rate to have the best possible evaporation of liquid and consequently more erosion control, in combination with the medium liquid absorbency and retention (2). In some embodiments, synthetic fabric with high density and absorbency can help to extend the lifespan and stable performance and increased duration of the energy systems. This is due in part to better breathing of the anode which is evidenced by the below comparative examples.

The following Examples are presented for the purpose of illustration and should not be construed as limiting.

### Comparative Example 1

A system of five metal element-rods (I) (anodes), connected in series and including the eight metal alloy of the embodiments, namely basically of magnesium (Mg) in an alloy of (Al), (Zn), (Mn), (Si), (Cu), (Ni) and (Fe), having length of 10 cm, width of 1.2 cm and thickness 0.3 cm, in combination with a liquid absorption and retention materials (2) made of a synthetic fabric of high density and absorbency as commercially available and an outer metal casing-sleeve (3) in the form of a pure copper sheet 0.12 cm, was immersed in drinking water and had an initial output of 7.35 Volt in open circuit, while after the connection to a charge of 3 Kohm the output was 2.80 Volt and 17.8 mA. After the first two hours and thirty minutes the system output marked a significant decline in 2.32 Volt and 7.8 mA. The test continued for twelve hours, when measurements were close to zero.

A system of five metal element-rods (1) (anodes) according to the present embodiments had the same metals as the ones mentioned above. The only difference is that they were housed in an outer metal casing-sleeve (3), made of pure copper in a braided form 48×54×0.07. This system had an initial output of 7.45 Volt in open circuit and after it was connected in a charge of 3 Kohm the output was 2.90 Volt and 26 mA. After the first two hours and thirty minutes the output of the system showed a small decline to 2.81 Volt and 23 mA and after fifteen hours the measurements were still in satisfactory levels in 2.57 Volt and 16 mA.

After forty hours of the systems being at rest and dry, it was again immersed in water and the electricity production and energy output were again maximized.

In the first system it is believed that the main element-rods were excessively swelled, because of the continuous and high degree erosion (close type system), having as a result the penetration of the interposed water retention materials, the short-circuit of the main element-rods with the outer metal casing sleeves and subsequently the indication was 0 Volt.

The second system after a few minutes from its immersion in water had an output of 7.43 Volt in open circuit and with a charge of 3 Kohm its output was 2.89 Volt and 24.8 mA. Within the first two hours it remained in satisfactory levels having a gradual decline of 12% after ten hours passed.

The above experiments show that through the outer metal casing-sleeve (3) of pure copper in braided form the stabilization ability of the chemical reaction is enhanced (stable energy efficiency). While not wishing to be bound to a particular theory, it is believed that the multi-collector copper conductors included in the braided form and operating as electron collectors caused this improvement. This particular braided form (48×54×0.07) provides the advantage of swelling elimination of the main inner metal element-rod so that a short-circuit is avoided (the swelling is simultaneous) and in addition, in combination with the above mentioned liquid retention material the anode reaches its best respiration ability and evaporation of the liquid element is enhanced, leading to controlled erosion.

The above comparative experiments show that the electric power production systems of the present embodiments will be of an open type and they will be surrounded by a perforated frame, so that the respiration of the anodes and the evaporation of the liquid element is facilitated, in contrast with the until now known batteries which are all of a close type.

After laboratory trials it has been shown that these particular systems connected in series have the ability to cover the lighting needs of a house for a long duration and continuous operation, (up to three years), because the use of pure copper in braided form knitted in 48×54×0.07 in combination with the particular liquid absorption and retention materials (2). Also, the use of additional electrolytes is not required.

The electric power generation system of the embodiments is characterized by having a repeated life cycle for many uses, given that contacting the system to water (or any other liquid) and then its drying out constitutes a cycle, then its life may last for up to one thousand such cycles, its efficiency depending on its resting time, with the optimal result of performance being achieved when its relaxation time equals its operating time.

Also contrary to closed system batteries, the present embodiments are not at a deterioration risk when it is not wetted and remains new and ready for use. This is due to the fact that the inner element-rod (I), is protected by ambient moisture by the liquid absorption and retention materials (2) comprising, for example, the high density and absorbency synthetic fabric mentioned above.

Additionally, the system of the present embodiments is capable of being stored after use for as long as required, for example, up to 20 years, provided that it has been thoroughly dried prior to storing. When reused the system provides substantially the same output without having undergone additional deterioration, thereby having a long lasting life duration. Therefore the system is suitable for and capable of serving numerous continuous and or even occasional uses.

In some embodiments, large applications of the systems can be completely autonomous. For example, they may bear two water feeding containers, the circular supply container system operating by means of the energy being generated by the application itself and not by some simple water system. The application startup can be carried out by means of water that is being placed in a first container and filled with water when required (usually every 30-50 days), which can be performed by any individual regardless of technical knowledge.

### Operation

In a few seconds, following immersing of the system in water (or any other liquid), chemical reactions are created between the main inner element-rod (1), the water (or any other liquid) stored in the absorption and retention materials (2) and the outer metal casing-sleeve (3). These chemical reactions result in the concentration of negative charges (− negative pole) in the main inner element-rod (!) and positive charges (+ positive pole) in the outer metal casing-sleeve (3). Due to the existence of this difference, a voltage is created between the main inner metallic element-rod (I) and the outer metal casing-sleeve (3) leading to the initiation of the erosion-corrosion process of the inner element-rod (I), which begins to lose electrons from its nucleus, so that by connecting a consumption source (an LED source for example) an electron flow is created from the inner element-rod (I), to the outer metal casing-sleeve (3) which electron flow is electricity. The erosion-corrosion of the inner element-rod (!) is due to the difference in positive oxidation potential, since it possesses a bigger positive potential than the outer metal casing-sleeve (3).

The description of the subject of the embodiments was made by reference to a first indicative and not at all restrictive embodiment of the embodiments and that alternatively, as it is known in the field, other metals could be used with difference in potential between them. Other materials could be used as the anode/cathode and in different forms with the intention of producing electric energy according to the present embodiments (e.g. open type systems) and the anode or cathode having a braided form for the purposes of the controlled erosion.

Some embodiments relate to electric power production systems comprising a main inner metal element-rod (1), an outer metal casing-sleeve (3) and liquid absorption and retention materials (2) being interposed between them, being characterized in that they are of an open type and use water to initiate and activate the electric power production process without the use of additional electrolytes, or with or without additional metals bearing a layer of a hydrogen catalyst. They are of an open type (controlled erosion) and they are surrounded from a perforated frame and capable of being activated to generate electricity within a few seconds after being immersed in water and operate continuously for as long as the main inner metal element-rod (1) is being kept moist.

In some embodiments, the main inner metal element rod (1), is made at least of magnesium (Mg).

In some embodiments, the inner metal element rod (1) is made of magnesium (Mg) as the main metal, in combination with at least one of the metals selected from the group including aluminum (Al), zinc (Zn), manganese (Mg), silicon (Si), copper (Cu), nickel (Ni) and iron (Fe).

In some embodiments, the metal element rod (1) is made by the mixture of an eight-metal polymer alloy, having magnesium (Mg) as the main metal, the rest of the metals have approximately the following proportions: aluminum (Al) from 5.3% to 6.7%, zinc (Zn) from 2.5% to 3.5%, manganese (Mn) from 0.15% to 0.8%, silicon 1 Si) 0.15% maximum, copper (Cu) 0.03% maximum, nickel (Ni) 0.003% maximum and iron (Fe) 0.003% maximum.

In some embodiments, the metal casing sleeve (3) has the braided form, which comprises multi-collector copper conductors.

In some embodiments, the metal casing sleeve (3) is made of 99% pure copper in a braided form of a 48×54×0.07 knitting, or it is made of copper of any knitting or of different chemical composition.

In some embodiments, the liquid absorption and retention material (2) is a high density and absorbency synthetic fabric made of cotton and cellulose in combination with a very thin layer of sodium polyacrylate or a cloth, sponge or any other material suitable for this purpose.

In some embodiments, the inner metal element rod (1) has different geometrical shapes.

Some embodiments relate to an autonomous electric power production application, that includes the electric power production system generator of the present embodiments. This application has a feeding container and a collecting container and is characterized in that the feeding of the system is powered by electric energy generated by the application itself, while the application startup is carried out by means of water being placed in the feeding container and being filled when required.

It should be stressed that the system of the present embodiments is capable of being manufactured in any size so that any electric energy generation requirements can be served. Thus the modification of any of the details mentioned above is covered by the present embodiments.

In summary, an electric power production system consists of a main inner metal element-rod (1), an outer metal casing-sleeve (3) and a liquid absorption and retention means (2) being interposed between them, and is characterized in that it uses water as a means of initiating and activation of the electric power production process.

The main inner metal element-rod (1), according to a first embodiment is made of a mixture of eight different metals, namely aluminum (Al), zinc (Zn), manganese (Mn), silicon (Si), copper (Cu), nickel (Ni), iron (Fe) and magnesium (Mg) and has the form of a cylindrical rod and the outer metal casing-sleeve (3) is made of copper in a braided form.

The main inner metal element-rod (1), can also be constructed in the form of any other geometrical shape other than cylindrical, as well as in any other dimension.

The outer metal casing-sleeve (3) can be constructed of copper of any form.

The liquid absorption and retention means (2) can be a fabric, a sponge and/or any other material suitable and convenient for this purpose.

According to a second embodiment, the system may also bear an integrated water supply storage-tank, by the opening of which the liquid absorption and retention means (2) is supplied with water so that the electric energy generation process can be activated directly.

According to a third embodiment, large systems designed to facilitate greater energy requirements can operate in combination with an automated moisture system, where in this case the initiation of electric energy generation process is carried out by immersion in water and thereafter is carried out automatically when required.

Following immersing of the system in water, chemical reactions are created between the main inner metal element-rod (1), the liquid stored in the absorption and retention means (2) and the outer metal casing-sleeve (3). These chemical reactions result in the concentration of negative charges (− negative pole) in the main inner the metal-rod (1) and positive charges (+ positive pole) in the outer metal casing-sleeve (3) and it is because of the existence of this difference that a voltage is created between the main inner metallic element-rod (1) and the outer metal casing-sleeve (3) leading to the initiation of the erosion-corrosion process of the inner metal element-rod (1), which begins to lose electrons from its nucleus, so that by connecting a consumption source—a LED source for example—an electron flow is created from the inner metal element-rod (1), to the outer metal casing-sleeve (3) which electron flow is electricity.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments.

That many variations and modifications may be made to the above-described embodiments, the elements of which are to be understood as being among other acceptable examples. All such modifications and variations are intended to be included herein within the scope of this disclosure.

While the foregoing written description enables one of ordinary skill to make and use what is considered presently to be the best mode thereof, those skilled in the art will understand and appreciate the existence of variations, combinations, and equivalents of the specific embodiment, method, and examples herein. The present embodiments should therefore not be limited by the above described embodiment, method, and examples, but by all embodiments and methods within the scope and spirit of the present embodiments.

What is claimed is:

1. An electric power production system-generator comprising a main inner element-rod (1), an outer metal casing-sleeve (3) and a liquid absorber and retainer (2) being interposed between them, being characterized in that it is of an open type and uses a liquid to initiate and activate the electric power production process—capable of being activated to generate electricity within a few seconds after being immersed in the liquid and operates continuously for as long as the main inner element-rod (1) is being kept moist—it requiring no addition of electrolyte and is indented for mobile and fixed energy purposes.

2. An electric power production system-generator according to claim 1 wherein the main inner element-rod (1), is made of an eight metal polymer alloy, namely aluminum (Al), zinc (Zn), manganese (Mn), silicon (Si), copper (Cu), nickel (Ni), iron (Fe) and magnesium (Mg) in the form of a cylindrical rod—the outer metal casing-sleeve (3) is made of 99% pure copper in a braided form of a 48×54×0,07 knitting—the liquid absorber and retainer (2) being a high density and absorbency synthetic fabric available in the market, preferably made of cotton and cellulose in combination with a very thin layer of sodium polyacrylate, it being capable of absorbing up to 300 times its own weight and the system is being enclosed in a perforated frame.

3. An electric power production system-generator according to claim 1 wherein it is by means of the outer metal casing-sleeve (3) of pure copper 99%, having a braided form and the specific knitting of 48×54×0,07, a more efficient respiration of the main inner metal element-rod (1) is provided, and therefore minor additional amounts of hydrogen are absorbed from the surrounding air, which in combination with the liquid absorber and retainer (2) being made of cotton and cellulose in combination with a very thin layer of sodium polyacrylate, contribute to device life duration being increased and to output and power duration being stable.

4. An electric power production system-generator according to claim 1 wherein, deterioration of the main internal element-rod (1) is being minimized, due to non use of additional electrolytes, this contributing to device life duration and performance being increased.

5. An electric power production system according to claim 1 wherein it is capable of having a repeated life cycle for many uses,—given that each system immersion in liquid and then its drying out constitutes a cycle, then its life may last up to one thousand such cycles—, its efficiency depending on its resting time, with the optimal performance result being achieved when its relaxation time equals its operating time.

6. An electric power production system according to claim 1 wherein is not at a deterioration risk for as long as is not wetted and remains brand new for the reason that the inner element-rod (1), is being fully protected from the ambient moisture by means of the liquid absorber and retainer (2) made of the high density and absorbency synthetic fabric.

7. An electric power production system according to claim 1 wherein the large applications are completely autonomous, for they bear two liquid feeding containers, the circular supply container system operating by means of energy being generated by the application itself, the application startup being carried out by liquid being placed in a first container and then being filled again when required (usually every 30-50 days), which can be done by any individual without any technical knowledge.

8. An electric power production system according to claim 1 capable of being stored after use for as long as required,—up to 20 years, provided that it has been thoroughly dried prior to storing—and when reused providing the same output without having undergone even the slightest additional deterioration, thus having a long lasting life duration and therefore is being suitable and capable of serving numerous continuous and or even occasional uses.

9. An electric power production system according to claim 1 wherein alternatively, the inner element-rod (1) has different geometrical shapes, the outer metal casing-sleeve (3) is made of copper of any kind of knitting and/or different chemical composition and the liquid absorber and retainer (2) is being a cloth, a sponge and/or any other material suitable for this purpose.

10. An electric power production system according to claim 1 wherein through the open type perforated frame, a further small hydrogen intake is facilitated from the surrounding air, which contributes on one hand, to chemical reactions being further enhanced, and on the other, to achieve the drying out of the main inner element-rod, and thus achieve a complete charge/discharge cycle. (1) Following an operating cycle as just described, any further deterioration is being prevented, this resulting to the life duration of the device being increased, and also to the achievement of a steady performance and increased output duration.

11. An electric power production system-generator comprises of a main inner element-rod (1), an outer metal casing-sleeve (3) and a liquid absorber and retainer (2) being interposed between them, being characterized in that it is of an open type and uses water to initiate and activate the electric power production process—capable of being activated to generate electricity within a few seconds after being immersed in water and operates continuously for as long as the main inner element-rod (1) is being kept moist—it requires no addition of electrolyte and is indented for mobile and fixed energy purposes.

12. An electric power production system-generator according to claim 11 wherein the main inner element-rod (1), is made of an eight metal polymer alloy, namely aluminum (Al), zinc (Zn), manganese (Mn), silicon (Si), copper (Cu), nickel (Ni), iron (Fe) and magnesium (Mg) in the form of a cylindrical rod—the outer metal casing-sleeve (3) is made of 99% pure copper in a braided form of a 48×54×0,07 knitting—the liquid absorber and retainer (2) being a high density and absorbency synthetic fabric available in the market, preferably made of cotton and cellulose in combination with a very thin layer of sodium polyacrylate, it being capable of absorbing up to 300 times its own weight and the system is being enclosed in a perforated frame.

13. An electric power production system-generator according to claim 11 wherein it is by means of the outer metal casing-sleeve (3) of pure copper 99%, having a braided form and the specific knitting of 48×54×0,07, a more efficient respiration of the main inner metal element-rod (1) is provided, and therefore minor additional amounts of hydrogen are absorbed from the surrounding air, which in combination with the liquid absorber and retainer (2) being made of cotton and cellulose in combination with a very thin layer of sodium polyacrylate, contribute to device life duration being increased and to output and power duration being stable.

14. An electric power production system-generator according to claim 11 wherein, deterioration of the main internal element-rod (1) is being minimized, due to non use of additional electrolytes, this contributing to device life duration and performance being increased.

15. An electric power production system according to claim 11 wherein it is capable of having a repeated life cycle for many uses,—given that each system immersion in water and then its drying out constitutes a cycle, then its life may last up to one thousand such cycles—, its efficiency depending on its resting time, with the optimal performance result being achieved when its relaxation time equals its operating time.

16. An electric power production system according to claim 11 wherein is not at a deterioration risk for as long as is not wetted and remains brand new for the reason that the inner element-rod (1), is being fully protected from the ambient moisture by means of the liquid absorber and retainer (2) made of the high density and absorbency synthetic fabric.

17. An electric power production system according to claim 11 wherein the large applications are completely autonomous, for they bear two water feeding containers, the circular supply container system operating by means of energy being generated by the application itself and not by some simple water system. The application startup is carried out by means of water being placed in a first container and then being filled again when required (usually every 30-50 days), which can be done by any individual without any technical knowledge.

18. An electric power production system according to claim 11 capable of being stored after use for as long as required,—up to 20 years, provided that it has been thoroughly dried prior to storing—and when reused providing the same output without having undergone even the slightest additional deterioration, thus having a long lasting life duration and therefore is being suitable and capable of serving numerous continuous and or even occasional uses.

19. An electric power production system according to claim 11 wherein alternatively, the inner element-rod (1) has different geometrical shapes, the outer metal casing-sleeve (3) is made of copper of any kind of knitting and/or different chemical composition and the liquid absorber and retainer (2) is being a cloth, a sponge and/or any other material suitable for this purpose.

20. An electric power production system according to claim 11 wherein through the open type perforated frame, a further small hydrogen intake is facilitated from the surrounding air, which contributes on one hand, to chemical reactions being further enhanced, and on the other, to achieve the drying out of the main inner element-rod, and thus achieve a complete charge/discharge cycle. (1) Following an operating cycle as just described, any further deterioration is being prevented, this resulting to the life duration of the device being increased, and also to the achievement of a steady performance and increased output duration.
